(19) United States
(12) Patent Application Publication
(10) Pub. No.: US 2016/0023167 A1
(43) Pub. Date: Jan. 28, 2016

(54) NANOCOMPOSITE WITH NANOCHANNELS OR NANOPORES FOR FILTRATION OF WASTE EFFLUENTS

(71) Applicants: Eva DEEMER, El Paso, TX (US); Russell R. CHIANELLI, El Paso, TX (US); BOARD OF REGENTS, THE UNIVERSITY OF TEXAS SYSTEM, Austin, TX (US)

(72) Inventors: Eva DEEMER, El Paso, TX (US); Russell R. CHIANELLI, El Paso, TX (US)

(21) Appl. No.: 14/776,148

(22) PCT Filed: Mar. 14, 2014
(86) PCT No.: PCT/US14/27467

§ 371 Date: Sep. 14, 2015

Related U.S. Application Data
(60) Provisional application No. 61/790,264, filed on Mar. 15, 2013.

(51) Int. Cl. B01D 71/02; C02F 1/44; B01D 69/12

(52) U.S. Cl. CPC B01D 71/021; B01D 69/12; C02F 1/44; C02F 2101/006

(57) ABSTRACT

The present invention includes a treatment system and methods for removing waste or other agents from a fluid stream, the system comprising: an inlet flow path for receiving a fluid stream from a source outside the treatment system; a vessel for containing the fluid stream, the vessel comprising a permeable filter configured for biological and physical treatment of the fluid stream, the filter comprising one or more nano-thin film or polymer composite layers of carbon materials assembled in sp2 hybridized structures comprising carbon-carbon bonds, wherein the waste or agent is removed as it flows through pores in the film composite; and a drain fluidly connected to the vessel for discharging treated fluid stream from the vessel from which the waste or agents have been removed.

### TECHNICAL FIELD OF THE INVENTION

The present invention relates in general to the field of filtration of waste streams, and more particularly, to nanocomposites with, e.g., nanochannels or nanopores, for filtration waste effluents.

### BACKGROUND ART

Without limiting the scope of the invention, its background is described in connection with filtration methods and compositions.

One such invention is found in U.S. Pat. No. 7,459,121, issued to Liang, et al., directed to a method for continuous fabrication of carbon nanotube networks or membrane materials. Briefly, this patent is said to teach methods and devices for the continuous production of a network of nanotubes or other nanoscale fibers. The method is also said to include making a suspension of nanoscale fibers dispersed in a liquid medium, optionally with surfactant and/or sonication, and filtering the suspension by moving a filter membrane through the suspension, such that the nanoscale fibers are deposited directly on the filter membrane as the fluid medium flows through the filter membrane, to form a continuous membrane of nanoscale fibers. The deposition of the nanoscale fibers can occur when and where the filter membrane moves into contact with a static, porous filter element or a dynamic, porous filter element. The filtering can be conducted within a magnetic field effective to align the nanoscale fibers, and/or with the aid of vacuum to pull water through the filter membrane, applied pressure to press water though the filter membrane, or a combination thereof

Another invention is said to be taught in U.S. Pat. No. 7,071,247, issued to Fischer, directed to a reinforced filter material. Briefly, this invention is said to teach a porous mold for use in a pressure casting process, which mold is manufactured of a polymeric material forming a matrix into which a clay and a block copolymer or a graft copolymer have been incorporated, wherein the block copolymer or graft copolymer comprises one or more first structural units (A), which are compatible with the clay, and one or more second structural units (B), which are compatible with the polymeric matrix. The invention further relates to a process for producing said mold and to the use of said mold in a pressure casting process.

United States Patent Application No. 20080185341, filed by Diallo, which is directed to water treatment by dendrimer-enhanced filtration. Briefly, the application teaches compositions and methods useful for the purification of aqueous fluids using dendritic macromolecules. The process is said to involve using dendritic macromolecules (dendrimers) to bind to or chemically transform solutes, and a filtration step to produce fluid from which solutes have been removed or chemically transformed. Examples of dendrimers that may be used in the process include cation-binding dendrimers, anion-binding dendrimers, organic compound-binding dendrimers, redox-active dendrimers, biological compound-binding dendrimers, catalytic dendrimers, biocidal dendrimers, viral-binding dendrimers, multi-functional dendrimers, and combinations thereof. The process is said to be readily scalable and provides many options for customization.

WO 2014/027197 A1 filed by Nair discloses uses of graphene oxide for vapor phase separation and methods of dehydration for the separation of water using a membrane. Graphene oxide was shown to allow unimpeaded permeation of water (Nair et al. Science, 2012, 335, 442-444) but this work does not disclose any practical applications on this material as a membrane. (cited in paragraph [0012] in WO 2014/027197 A1).

### DISCLOSURE OF THE INVENTION

The present invention includes a treatment system and methods for removing waste or other agents from a fluid stream, the system comprising: an inlet flow path for receiving a fluid stream from a source outside the treatment system; a vessel for containing the fluid stream, the vessel comprising a permeable filter configured for biological and physical treatment of the fluid stream, the filter comprising one or more nano-thin film or polymer composite layers of carbon materials assembled in sp2 hybridized structures comprising carbon-carbon bonds, wherein the waste or agent is removed as it flows through pores in the film composite; and a drain fluidly connected to the vessel for discharging treated fluid stream from the vessel from which the waste or agents have been removed. In one aspect, the filter further comprises at least one of graphene materials with heteroatoms such as oxygen, nitrogen, hydrogen, sulfur, or other metal containing species such as a metal dichalcogenide. In another aspect, the filter is made permeable by at least one of chemical doping with heteroatoms, chemical destruction of lattice by UV-Ozone treatments, chemical disruption of the lattice by bonding or by removal of areas using plasma, or electron beam lithography. In another aspect, the filter comprises at least one channel opening for receiving the fluid stream. In another aspect, the filter comprises connecting elements to releasably connect a unit of stackable filter units that comprise one or more filters. In another aspect, the fluid stream comprises a gas or a liquid. In another aspect, the fluid stream comprises water, wastewater, oil, grease, biological entities, chemical dyes, heavy and radioactive waste. In another aspect, the filter isolated the agent, wherein the agent is in extraction solvents that comprise petrochemicals, removal of free fatty acids, desulfurization, deacidification, solvent recovery in lube dewaxing, isolation and concentration of pharmaceuticals, and concentration and purification of bioactive compounds. In another aspect, the filter comprises a single or multilayered thin layer composite. In another aspect, the water is treated as it flows through pores in the film composite gravity. In another aspect, the filtration is cross-flow, spiral wound or dead-end filtration. In another aspect, the different size nanochannels between or across sheets are functionalized with one or more heteroatoms to control the size exclusion of filtration. In another aspect, the different specificity of one or more nanochannels formed between or across sheets are functionalized with one or more heteroatoms to control the specificity of filtration. In another aspect, the filter is a graphene or graphene oxide filter.

Yet another embodiment of the present invention includes a filter comprising a plurality of stackable filter units, each of the filter units having a first planar surface and a second planar surface, the second planar surface having a filtering wall extending therefrom to an edge, wherein the second planar surface is designed for stacking alignment with the first planar surface of an adjacent filter unit and wherein the edge forms a filter aperture with the first planar surface of the adjacent filter unit, wherein the filter comprises nano-thin film or polymer composite layers of carbon materials assemble in sp2 hybridized structures comprising carbon-carbon bonds. In one aspect, the filter further comprises at least one of graphene materials with heteroatoms such as oxygen, nitrogen, hydrogen, sulfur or other metal containing species. In another aspect, the filter is made permeable by at least one of chemical doping with heteroatoms, chemical destruction of lattice by UV-Ozone treatments, chemical disruption of the lattice by bonding or by removal of areas using plasma, or electron beam lithography. In another aspect, the filter comprises at least one channel opening for receiving the fluid stream. In another aspect, the filter comprises connecting elements to releasably connect a unit of stackable filter units that comprise one or more filters. In another aspect, the fluid stream comprises a gas or a liquid. In another aspect, the fluid stream comprises water, wastewater, oil, grease, biological entities, chemical dyes, heavy and radioactive waste. In another aspect, wherein the filter isolated the agent, wherein the agent is in extraction solvents that comprise petrochemicals, removal of free fatty acids, desulfurization, deacidification, solvent recovery in lube dewaxing, isolation and concentration of pharmaceuticals, and concentration and purification of bioactive compounds. In another aspect, the filter comprises a single or multilayered thin layer composite, wherein each layer comprises a different modification made by at least one of chemical doping with heteroatoms, chemical destruction of lattice by UV-Ozone treatments, chemical disruption of the lattice by bonding or by removal of areas using plasma, or electron beam lithography. In another aspect, the water is treated as it flows by gravity through pores in the film composite. In another aspect, the filtration is cross-flow, spiral wound or dead-end filtration. In another aspect, the different size nanochannels between or across sheets are functionalized with one or more heteroatoms to control the size exclusion of filtration. In another aspect, the different specificity of one or more nanochannels formed between or across sheets are functionalized with one or more heteroatoms to control the specificity of filtration.

In another embodiment, the present invention includes a method for filtering waste or an agent from a fluid stream, the method comprising: receiving a fluid stream from a source outside a treatment system; contacting the fluid stream with a filter configured for biological and physical treatment of the wastewater, the filter comprising one or more nano-thin film or polymer composite layers of carbon materials assemble in sp2 hybridized structures comprising carbon-carbon bonds, wherein the wastewater is treated as it flows by gravity through pores in the film composite; and draining a discharge fluid stream from the treatment system. In one aspect, the filter further comprises at least one of graphene materials with heteroatoms such as oxygen, nitrogen, hydrogen, sulfur or other metal containing species. In another aspect, the filter is made permeable by at least one of chemical doping with heteroatoms, chemical destruction of lattice by UV-Ozone treatments, chemical disruption of the lattice by bonding or by removal of areas using plasma, or electron beam lithography. In another aspect, the filter comprises at least one channel opening for receiving the fluid stream. In another aspect, the filter comprises connecting elements to releasably connect a unit of stackable filter units that comprise one or more filters. In another aspect, the fluid stream comprises a gas or a liquid. In another aspect, the fluid stream comprises water, wastewater, oil, grease, biological entities, chemical dyes, heavy and radioactive waste. In another aspect, the filter isolated the agent, wherein the agent is in extraction solvents that comprise petrochemicals, removal of free fatty acids, desulfurization, deacidification, solvent recovery in lube dewaxing, isolation and concentration of pharmaceuticals, and concentration and purification of bioactive compounds. In another aspect, the filter comprises a single or multilayered thin layer composite. In another aspect, the method further comprises the step of pre-filtering large solids before entering the filter. In another aspect, the water is treated as it flows through pores in the film composite gravity. In another aspect, the filtration is cross-flow, spiral wound or dead-end filtration. In another aspect, the different size nanochannels between or across sheets are functionalized with one or more heteroatoms to control the size exclusion of filtration. In another aspect, the different specificity of one or more nanochannels formed between or across sheets are functionalized with one or more heteroatoms to control the specificity of filtration. In another aspect, the filter is a graphene or graphene oxide filter.

Another embodiment of the present invention includes a treatment system for removing waste or other agents from a fluid stream, the system comprising: an inlet flow path for receiving a fluid stream from a source outside the treatment system; a permeable filter configured for biological and physical treatment of the fluid stream, the filter comprising one or more nano-thin film or polymer composite layers of carbon materials assembled in sp2 hybridized structures comprising carbon-carbon bonds, wherein the waste or agent is removed as it flows through pores in the film composite; and a drain for discharging treated fluid stream from which the waste or agents have been removed. In another aspect, the filter is made permeable by at least one of chemical doping with heteroatoms, chemical destruction of lattice by UV-Ozone treatments, chemical disruption of the lattice by bonding or by removal of areas using plasma, or electron beam lithography. In another aspect, the filter comprises at least one channel opening for receiving the fluid stream. In another aspect, the filter comprises connecting elements to releasably connect a unit of stackable filter units that comprise one or more filters. In another aspect, the fluid stream comprises a gas or a liquid. In another aspect, the fluid stream comprises water, wastewater, oil, grease, biological entities, chemical dyes, heavy and radioactive waste. In another aspect, the filter isolated the agent, wherein the agent is in extraction solvents that comprise petrochemicals, removal of free fatty acids, desulfurization, deacidification, solvent recovery in lube dewaxing, isolation and concentration of pharmaceuticals, and concentration and purification of bioactive compounds. In another aspect, the filter comprises a single or multilayered thin layer composite. In another aspect, the water is treated as it flows through pores in the film composite gravity. In another aspect, the filtration is cross-flow, spiral wound or dead-end filtration. In another aspect, the different size nanochannels between or across sheets are functionalized with one or more heteroatoms to control the size exclusion of filtration. In another aspect, the different specificity of one or more nanochannels formed between or across sheets are functionalized with one or more heteroatoms to control the specificity of filtration. In another aspect, the filter is a graphene or graphene oxide filter.

The present invention provides a treatment system for removing one or more agents from a fluid stream, the treatment system comprising: a vessel housing comprising a housing inlet and a housing outlet; an inlet flow path fluidly connected to the housing inlet to transport a fluid stream from a source to the vessel housing; a drain fluidly connected to the housing outlet to discharge a treated fluid stream from the vessel; a permeable graphene filter for biological treatment, physical treatment or both of the fluid stream positioned between the housing inlet and the housing outlet to remove one or more agents from the fluid stream to form the treated fluid stream, wherein the permeable graphene filter comprises a polymer composite of one or more layers of a graphene material assembled in sp2 hybridized structures comprising carbon-carbon bonds and the permeable graphene filter is made permeable by chemical doping with heteroatoms, chemical destruction of lattice by UV-Ozone treatments, chemical disruption of the lattice by bonding or by removal of areas using plasma, or electron beam lithography.

The graphene material comprises a graphene or a graphene oxide and further include one or more heteroatoms selected from oxygen, nitrogen, hydrogen, sulfur, or one or more metals. The permeable graphene filter may include at least one channel opening for receiving the fluid stream and may be a single or multilayered thin layer composite. The vessel housing comprises 2 or more permeable graphene filters. The 2 or more permeable graphene filters may include different size nanochannels positioned between or across the 2 or more permeable graphene filter and functionalized with one or more heteroatoms to control a size exclusion of a filtration, to control a specificity of a filtration or both. The 2 or more permeable graphene filters may be 2, 3, 4, 5, 6, 7, 8, 9, 10, 11, 12, 13, 14, 15, 16, 17, 18, 19, 20, 25, 30, 40, 50 or more graphene filters. The 2 or more permeable graphene filters may be cross-flow, spiral wound or dead-end filtration or a combination thereof The fluid stream may be a gas, a liquid, or a combination that may or may not include solids. The fluid stream comprises one or more selected from water, wastewater, oil, grease, oil, biological molecules, chemicals, organic molecules, inorganic molecules, chemical dyes, petrochemicals, pharmaceuticals, heavy and radioactive waste. The permeable graphene filter extracts solvents that comprise petrochemicals, removes free fatty acids, performs a desulfurization, performs a deacidification, performs a solvent recovery in lube dewaxing, isolates and/or concentrates pharmaceuticals, or concentration and/or purifies bioactive compounds.

The present invention provides a stackable filter unit comprising: 1 or more permeable graphene filters wherein each or the 1 or more permeable graphene filters comprise a first planar surface opposite a second planar surface separated by a filtering wall, wherein the second planar surface is designed to mate with the first planar surface of a second permeable graphene filter a nano-thin film or polymer composite layer for biological treatment, physical treatment or both placed in contact with the first planar surface, the second planar surface or both, wherein the nano-thin film or polymer composite layer comprises one or more layers of a graphene material assembled in sp2 hybridized structures comprising carbon-carbon bonds and the permeable graphene filter is made permeable by chemical doping with heteroatoms, chemical destruction of lattice by UV-Ozone treatments, chemical disruption of the lattice by bonding or by removal of areas using plasma, or electron beam lithography.

The graphene material comprises a graphene or a graphene oxide and further include one or more heteroatoms selected from oxygen, nitrogen, hydrogen, sulfur, or one or more metals. The permeable graphene filter may include at least one channel opening for receiving the fluid stream and may be a single or multilayered thin layer composite. The vessel housing comprises 2 or more permeable graphene filters. The 2 or more permeable graphene filters may include different size nanochannels positioned between or across the 2 or more permeable graphene filter and functionalized with one or more heteroatoms to control a size exclusion of a filtration, to control a specificity of a filtration or both. The 2 or more permeable graphene filters may be 2, 3, 4, 5, 6, 7, 8, 9, 10, 11, 12, 13, 14, 15, 16, 17, 18, 19, 20, 25, 30, 40, 50 or more graphene filters. The 2 or more permeable graphene filters may be cross-flow, spiral wound or dead-end filtration or a combination thereof The fluid stream may be a gas, a liquid, or a combination that may or may not include solids. The fluid stream comprises one or more selected from water, wastewater, oil, grease, oil, biological molecules, chemicals, organic molecules, inorganic molecules, chemical dyes, petrochemicals, pharmaceuticals, heavy and radioactive waste. The permeable graphene filter extracts solvents that comprise petrochemicals, removes free fatty acids, performs a desulfurization, performs a deacidification, performs a solvent recovery in lube dewaxing, isolates and/or concentrates pharmaceuticals, or concentration and/or purifies bioactive compounds.

The present invention provides a method for filtering waste or an agent from a fluid stream, the method comprising: receiving a fluid stream from a source outside a treatment system; and contacting the fluid stream with a permeable graphene filter configured for biological and physical treatment of the wastewater by removing one or more agents from the fluid stream to form the treated fluid stream, wherein the permeable graphene filter comprises a polymer composite one or more layers of a graphene material assembled in sp2 hybridized structures comprising carbon-carbon bonds and the permeable graphene filter is made permeable by chemical doping with heteroatoms, chemical destruction of lattice by UV-Ozone treatments, chemical disruption of the lattice by bonding or by removal of areas using plasma, or electron beam lithography; and discharging the treated fluid stream from the treatment system.

The graphene material comprises a graphene or a graphene oxide and further include one or more heteroatoms selected from oxygen, nitrogen, hydrogen, sulfur, or one or more metals. The permeable graphene filter may include at least one channel opening for receiving the fluid stream and may be a single or multilayered thin layer composite. The vessel housing comprises 2 or more permeable graphene filters. The 2 or more permeable graphene filters may include different size nanochannels positioned between or across the 2 or more permeable graphene filter and functionalized with one or more heteroatoms to control a size exclusion of a filtration, to control a specificity of a filtration or both. The 2 or more permeable graphene filters may be 2, 3, 4, 5, 6, 7, 8, 9, 10, 11, 12, 13, 14, 15, 16, 17, 18, 19, 20, 25, 30, 40, 50 or more graphene filters. The 2 or more permeable graphene filters may be cross-flow, spiral wound or dead-end filtration or a combination thereof The fluid stream may be a gas, a liquid, or a combination that may or may not include solids. The fluid stream comprises one or more selected from water, wastewater, oil, grease, oil, biological molecules, chemicals, organic molecules, inorganic molecules, chemical dyes, petrochemicals, pharmaceuticals, heavy and radioactive waste. The permeable graphene filter extracts solvents that comprise petrochemicals, removes free fatty acids, performs a desulfurization, performs a deacidification, performs a solvent recovery in lube dewaxing, isolates and/or concentrates pharmaceuticals, or concentration and/or purifies bioactive compounds.

### DESCRIPTION OF THE DRAWINGS

For a more complete understanding of the features and advantages of the present invention, reference is now made to the detailed description of the invention along with the accompanying figures and in which:

FIG. 1A a dead-end flow filtration apparatus that can be used with the filters of the present invention. FIG. 1B shows a cross-flow filtration apparatus for use with the present invention.

FIG. 2 shows a filter of the present invention made by vacuum assisted assembly.

FIG. 3 shows a nanocomposite filter that retains the surface energy of the substrate it was fabricated on;

FIG. 4 shows the strength and flexibility of a filter of the present invention;

FIG. 5 shows wastewater that includes grease prior to filtration (left, beaker) and after filtration using the present invention the filtrate (right, in the graduated cylinder).

FIG. 6 is a graph of the material tap water flux in gallons per foot per day using membrane synthesized using Synthesis procedure 1, 2 and 3.

FIG. 7 is a graph of the rejection of total dissolved solids from tap water using membrane synthesized using Synthesis procedure 1, 2 and 3.

FIG. 8 shows wastewater from hydraulic fracturing prior to filtration (left, beaker) and after filtration using the present invention the filtrate (right, in the graduated cylinder).

FIG. 9 is a plot of the percentage removal of total carbon, organic carbon, inorganic carbon, and total nitrogen.

FIG. 10 is a plot of the rejection of total dissolved solids using membrane synthesized using Synthesis procedure 1, 2 and 3.

FIG. 11 is a plot of the in gallons per foot per day using membrane synthesized using Synthesis procedure 1, 2 and 3.

FIG. 12 is an image of a single layer material of the present invention.

FIG. 13 is an Atomic Force Microscope (AFM) image of a single layer 1.5 μm in diameter.

FIG. 14A is an image of the AFM measurement of single layer thickness of a graphene oxide flake. FIG. 14B is an Atomic Force Microscope (AFM) image of a single layer graphene oxide flake with a ˜2 nm height.

FIG. 15A is an image of the stock solution of nanomaterial and FIG. 15B is an image of the dilute solution prepared for membrane deposition.

FIG. 16A is an image of the preparation of flat sheet polypropylene and FIG. 16B is an image of leveled vacuum deposition chamber.

FIG. 17 is an image of the unreated hydrophilic nanomaterial membrane on the right and the hydrophilic nanomaterial membrane pretreated with soap solution dried after deposition on the left.

FIG. 18 is an image of the membrane with a nanomaterial thin film on the right and the membrane without nanomaterial on the left.

FIG. 19 is a graph of the TDS testing % R for GO membranes.

FIG. 20 is a graph of the material flux for GO membranes.

FIG. 21 is a graph of the influence of the amount of IGO per area.

### DESCRIPTION OF EMBODIMENTS

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present disclosure is related to the purification of liquids and gases preferably and primarily intended for the disclosure is fluid purification. The present disclosure relates to a treatment system for removing waste or other agents from a fluid stream, the system includes an inlet flow path for receiving a fluid stream from a source outside the treatment system; a vessel for containing the fluid stream, the vessel comprising a permeable filter configured for biological and physical treatment of the fluid stream, the filter comprising one or more nano-thin film or polymer composite layers of carbon materials assembled in sp2 hybridized structures comprising carbon-carbon bonds, wherein the waste or agent is removed as it flows through pores in the film composite; and a drain fluidly connected to the vessel for discharging treated fluid stream from the vessel from which the waste or agents have been removed.

Graphite oxide is the precursor to graphene oxide and is chemically identical but structurally different. Graphite oxide is usually converted to graphene oxide using methods such as sonication and stirring to create a dispersion. If the solution used is polar than graphite oxide is exfoliated via the electronegative repulsion due to strongly negative charges between oxygen functional groups. These repulsion forces have been known to vary according to pH (B. C. Brodie, Philos. Trans. R. Soc. London, 1859, 149, 249-259) and have been exploited as a means of tuning interactions between water transport and rejection in membranes comprised of graphene oxide (Hubiao Huang, Chem. Commun, 2013, 49, 5963-5965).

As mentioned before, each method imparts differences in structure to the graphite oxide product which leaves some question and debate as to the definition of graphite oxide. Recent models reject the idea of a repeating lattice and accept a non-stoichiometric amorphous model described by Lerf and Klinowski (H. He, J. Klinowski, M. Forster and A. Lerf, Chem Phys. Lett., 1998, 287, 53-36) which increases the complexity surrounding the definition of graphite oxide and graphene oxide. Complexities surrounding graphene oxide itself depend further on methods of exfoliation (J. I. Paredes, S. Villar-Rodil, A. Martinez-Alanso and J. M. D Tascon, Langmuir, 2008, 24, 10560-10564). The degree of oxidation can be demonstrated using dispersion tests (Y. Si. And E. T. Samulski, Nano. Lett., 2008, 8, 1679-1682) and can also describe with increasing epoxide to alcohol ratio (D. W. Boukhvalov and M. I. Katsnelson, J. Am. Chem. Soc., 2008, 130, 10697-10701). Collectively, models accept that the products of oxidation are hydroxyl and epoxide groups on the basal plan of graphite oxide flakes and carboxylic acids on the edges (W. Cai, R. D. Piner, et al., Science, 2008, 321, 1815-1817) and these functionalities serve as reactive sites for functionalization or reduction. Moreover, the role of oxidization protocol fundamentally contributes to the structure, reactivity and overall function of graphite oxide. By restoring TE bonding, the electrical conductivity can be restored within graphene oxide. As mentioned, graphite oxide has mainly epoxides and alcohols on the basal planes. These are the primary sites for chemical reduction. However, reduction can also impart damage to the graphene basal planes and disrupt the lattice structure.

Most food processes in the industry are aqueous but in sometimes organic solvents are required. For treatment of aqueous streams around 300,000 m² of Nanofiltration-membranes are currently assumed to be applied in the food industry, mainly in the diary and industry. Solvents were first applied in the vegetable oil industry, where acetone (for triglyceride fractionation) and especially hexane (for oil extraction) are used; also in the synthesis of some food additives. Initial studies in the 1980s resulted in several large-scale trials, but the disappointing results have dampened the enthusiasm of researchers in the field. However, the large potential of membrane applications combined with new developments, re-initiated Solvent Resistant INF-research in this field over the past years. The main motives are the possibility to separate molecules in a customized manner, recycle solvents, reduce waste, and minimize thermal damage and lower energy consumption.

Membranes require much interdisciplinary knowledge in materials science and engineering, chemical synthesis, and skills in characterization for analytical purposes of evaluating membrane manufacturing, modification, and module design. A close integration between process-design in industrial application is imperative to addressing economical, ecological and health and safety issues.

Performance can be defined by the selectivity and the flux or permeation rate which is defined by the volume of liquid that flows through the membrane per unit are per unit time and is generally in units of 1/m² hr. Rejection can be defined as Cp−Cf/Cp where Cf and Cp denote feed and permeate concentrations. Separation performance is also evaluated by molecular weight cut-off (MWCO) usually identified using a reference compound 90% retained. It can be established by a curve showing membrane rejection of analytes with increasing molecular weights.

Although the performance of membranes has been studied by many authors, data in the literature is rather application-specific and difficult to compare. Specific properties of solutes and solvents (structure, size charge, concentration) as well as experimental parameters (pressure, temperature) make data very application specific and must be considered before interpreting data.

Most data is collected from dead-end filtration and is not necessarily reproducible in long term testing or under cross-flow filtration. A module type is used for most industrial applications sold containing a spiral wound membranes. For upscale and industrial purposes operational strategies (batch, continuous, or diafiltration) should be considered for performance along with the design of membrane system (dead-end [DE], cross-flow [CF]). DE involves pressurization of feed with a gas. Gas dissolves in feed stream and expansion of soluble gas going from feed pressure to atmospheric pressure in permeate have not formally been studied. CF general displays high flux and although the effect of concentration polarization is unknown, fouling usually results in high selectivity and overall rejection.

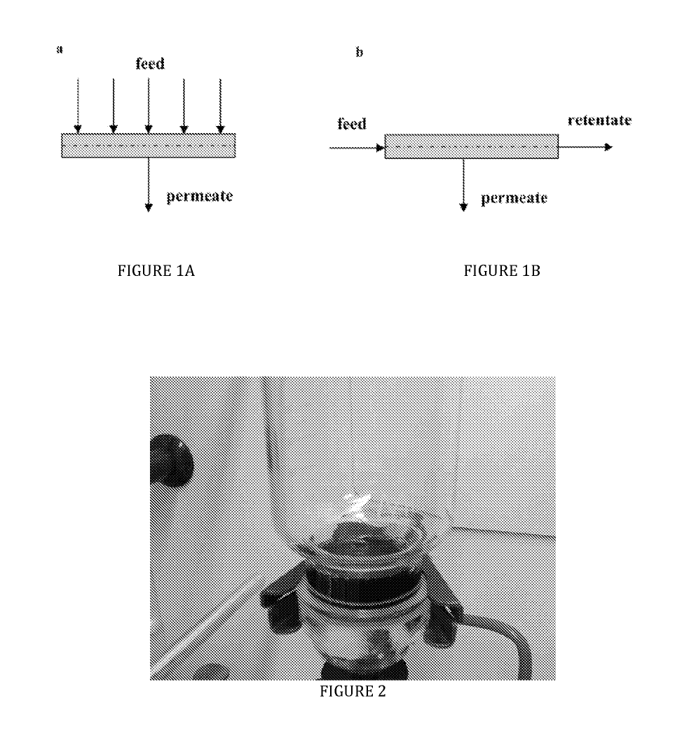

FIG. 1A shows a dead-end flow filtration apparatus that can be used with the filters of the present invention. FIG. 1B shows a cross-flow filtration apparatus for use with the present invention in which the various layers can be made to include pores of different sizes for size exclusion, and/or different functional groups that can provide size, charge, shape, or chemical specificity to the filter or parts of the filter of the present invention.

Fouling of membrane is defined by deposition of dissolved material on the external surface of the membrane or in its pore openings and pores. Concentration polarization is a fouling mechanism caused by accumulation of retained solutes and membrane boundary layer. This boundary layer concentration influences flux and rejection and can complicate data interpretation. A gel-like layer created by retained compounds increases osmotic pressure but is ultimately a reversible process controlled by technical modifications such as permeate pulsing, CF velocity and ultrasound.

A nano thin film composite material can be constructed from carbon materials, which are assemble in sp2 hybridized structures comprising carbon-carbon bonds. In other embodiments these structures may also comprise of graphene materials with heteroatoms such as oxygen, nitrogen, hydrogen, sulfur or other metal containing species. These carbon composite structures or graphene material membranes can be have a variety of uses such as electrodes, sensors, lithium batteries, touch screens, photovoltaics and electronics.

In this particular embodiment, a material that is normally impermeable is made permeably through creation of nanopores; either from chemical doping with heteroatoms, chemical destruction of latitce by UV-Ozone treatments, chemical disruption of the lattice by bonding or by removal of areas using plasma, electron beam lithography. Also in this particular embodiment, this composite material can be made permeable through nanochannels with a variety of interlayer spacing associated to chemical functionalities.

The composite intended for use can have one layer or have multiple layers. This composite may also be supported or unsupported.

The primary use of the invention is in the purification of grease trap interceptor waste. However this invention is not limited to oil/water separation. It can also be shown to remove biological entities from waste effluents, also in the removal of chemical dyes, in the removal of heavy metals such as chromium and arsenic from water. It can also be shown to have an effect on the removal of radioactive waste from water.

Fluid purification is not limited to water and the particular invention may be applied to petrochemicals in the recovery of extraction solvents, removal of free fatty acids, desulfurization, deacidification, solvent recovery in lube dewaxing, isolation and concentration of pharmaceuticals, and in the concentration and purification of bioactive compounds.

The present invention is a nanomaterial comprised of graphene material, either multilayered or single layer; containing all sp2 hybridized carbon-carbon bonds or having heteroatoms like oxygen, sulfur, nitrogen, hydrogen or metallic species present within graphene sheets or containing nanochannels created from functionalities.

The material composite can be made into a single or multilayered thin layer composite (TFC) and offers an improvement over current technologies such as reverse osmosis filtration due to increases in flux and rejection of impurities.

Several novel methods for producing graphene from inexpensive materials are envisioned. Methods for producing these materials can involve the application of sonic or microwave energy during the production.

In one method, the present invention includes a membrane fabricated using PTFE filter resulting in a thick membrane. The total drying time for this membrane was >5 days which is very long (too long) and this is due to the fact the PTFE is hydrophobic and contributed to a very slow filtration. The result was a thick membrane, which was simply tested for basic permeation properties. The patterned front and back demonstrates unique properties belonging to thin sheets (e.g., single layer) of graphene stacking that maintains the shape of the backing used during the formation of the filter and that is removed from the membrane. Briefly, graphene oxide in solution is placed on a filter backing or substrate and the membrane is grown on the backing or substrate. The filter can be a single layer that is made porous by chemical, mechanical, electrical and/or electromechanical forces, multiple layers that are also made porous by the listed methods, and/or the various layers are formed together or separately and are then combined to form layers with various characteristics that provide variable filtration, e.g., for cross-flow filtration. Filtration can be driven by, e.g., gravity, gravity-assisted, counter-current filtration, pressure-assisted and/or driven by an electrical current, e.g., electroporation, or a chemical gradient. The membrane may include pores that are chemical or biological that can also provide specificity to filtration. Other methods for driving filtration can also be used with the filters of the present invention, as can pre-filtering layers that help eliminate small, medium or large solids that could foul the membrane (e.g., small particulates, sand, or rock, respectively).

In one embodiment, the filters are used in dead-end filtration, cross-flow filtration or spiral wound, combinations thereof and other configurations. The filters may be made by: using Nitric Acid and Sulfuric acid (2:1 v/v), KMnO₄ and Carbon, (e.g., Sigma Aldrich cat #33241 natural graphite flakes sieved to 420 μm and 250 μm; SP-1Bay Carbon 30 μm graphite).

Three hydrocarbon composited can include: Hydrocarbon composite #1 Isolate with dodecane. Hydrocarbon composite #2 Isolated with heptane. Hydrocarbon composite #3 synthesized with maltenes. In operation, the filters may be made by: 1. Carbon (graphite) is added to acid and submerged in ice; 2. KMnO₄ is added over a period of time between 5 days and 30 min while stirring at a temperature between 35-65° C.; 3. The reaction of step 2 is poured into 200 ml of water and further stirred for a period of time between 15 min and 2 days; 4. The reaction in step 3 is quenched in 500 ml of water containing H₂O₂ and recovered through filtration.

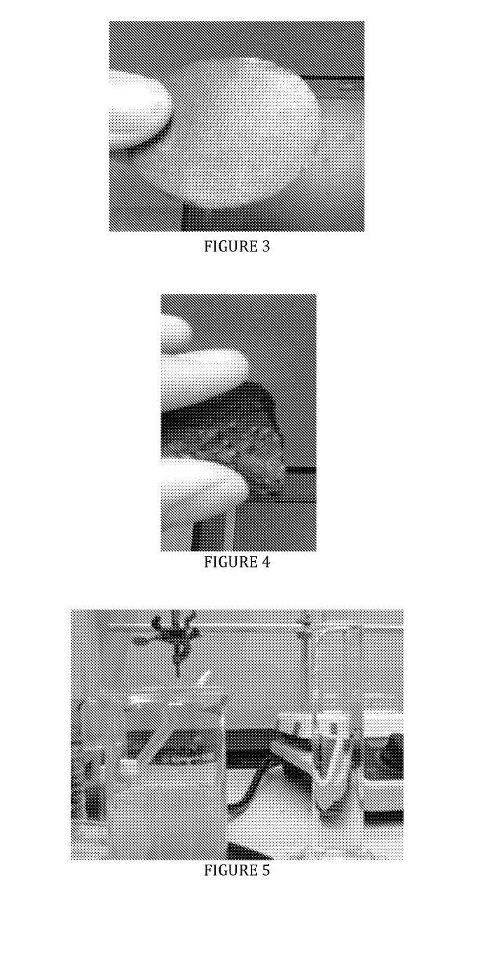

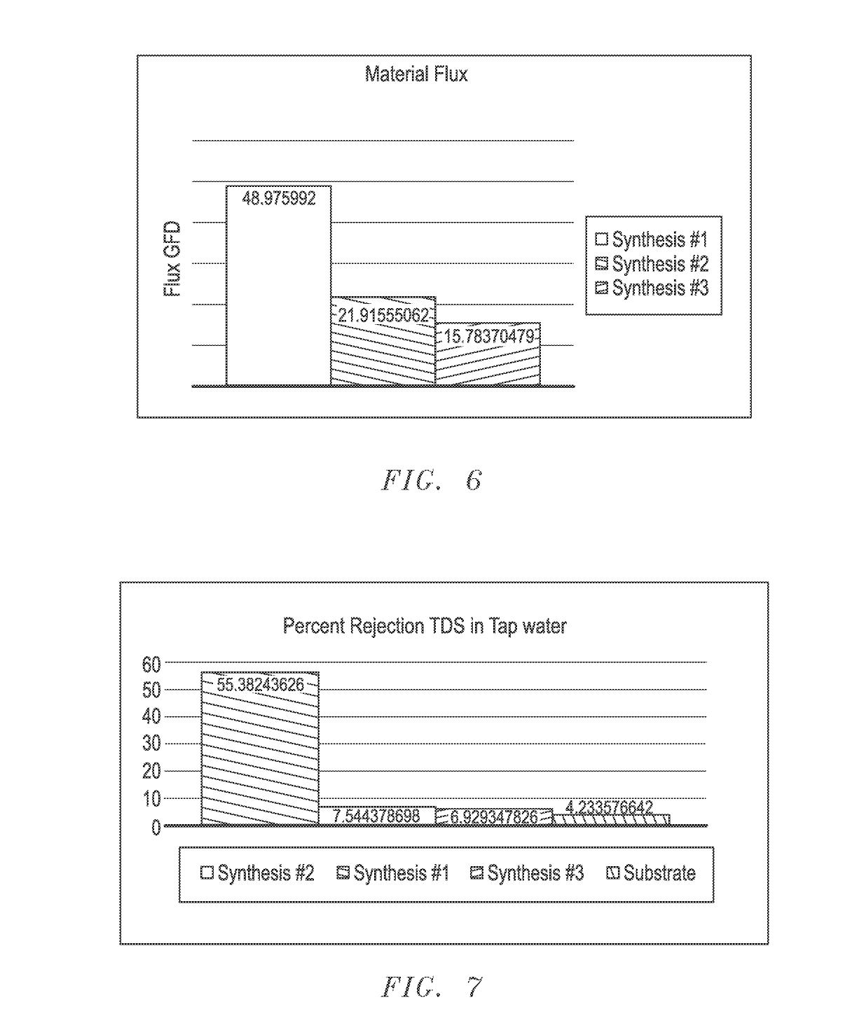

FIG. 2 shows a filter of the present invention made by vacuum assisted assembly. FIG. 3 shows a nanocomposite filter that retains the surface energy of the substrate it was fabricated on. FIG. 4 shows the strength and flexibility of a filter of the present invention. FIG. 5 shows wastewater that includes grease prior to filtration (left, beaker) and after filtration using the present invention the filtrate (right, in the graduated cylinder).

Using the present invention it was found that the processed filtrate included Total Dissolved Solids (TDS) using EPA method 106.1 of 450 mg/ml before filtration and of 113 mg/ml after filtration.

Hydrazine was the first reported and although extensively characterized reduction (S. Stankovich, D. A. Dinkin, et. al., Carbon, 2007, 45, 1558-1565.), has no clear mechanism. C:O ratio was measured to be 10.3:1 in the instance of reduction of graphene oxide in solution between 80-100° C. (K. R. Koch, P. F. Krause, J. Chem. Ed., 1982, 59, 973-974) and a black precipitate was reported. The materials surface area was reported to be much lower than surface area measured for pristine graphene: 466 m² g⁻¹ instead of 2620 m² g⁻¹. It is hypothesized that the reduction process increases the hydrophobicity of the material by removal of polar groups and that exfoliation of platelets can become difficult. Additionally, hydrazine in particular is known for introducing heteroatomic impurities suck as nitrogen which can remain covalently bound to the surface of graphene oxide. This has a dopant effect creating n-type graphene as a result (S. J. Kanh, et.al, Nat. Nanotechol. 2007, 2, 230-236). C:N ratios as low as 16:1:1 have been shown in elemental analysis.

Sodium borohydride (NaBH₄) is demonstrated to provide a more stable and effective reduction that Hydrazine. Its ability to reduce C═O groups is more effective than its ability to reduce carboxylic acids and epoxides (H. J. Shin, et. al, Adv. Funct. Mater., 2009, 19, 1987-1992.) and the primary impurity produced in this reduction is alcohol groups. It can be hydrolyzed by water but usually if in excess, it can be effective in freshly prepared solutions.

Thermal reduction can be achieved by directly heating GO in a furnace or by heating in solution via hydrothermal reduction methods (J. N. Ding, et. al, Diamonds & Related Materials, 2012, 12, 11-15).

Experiments useful for characterizing properties of reduced product include Raman spectroscopy where D and G bands are observed as measurements of order/disorder of the structure and the stacking order, measurements of surface area using BET analysis and sheet resistance and bulk conductivity. ATM, XPS, SEM and TEM are also useful for determining platelet size, structure and thickness.

Examples of the various synthesis protocols of the present invention include: Synthesis procedure 1 includes: add 3 g graphite to 69 ml H₂SO₄, on ice gradually add 9 g KMnO₄, Stir for 2 hrs at 35° C., add 130 ml H₂O and stir for 15 min, add to 270 ml H₂O_{d 2} and neutralize using H₂O₂, recover Graphite Oxide by filtration, and wash with HCl:H₂O (1:10 v/v) until sulfate free. Synthesis procedure 2 includes: add 3 g graphite to H₂SO₄:H₃PO₄ (9:1)-360 ml/40 ml, gradually add 18 g KMnO₄, stir for 12 hrs at 45° C., pour over 400 ml ice after mixture cools to room temperature, neutralize using H₂O₂ (3 ml), and wash with HCl:H₂O (3:7 v/v) until sulfate free. Synthesis procedure 3 includes: add 3 g graphite to 400 ml to H₂SO₄, after 10 min of stirring add (carefully) 3 g KMnO₄, add 3 g KMnO₄ each day for 3 more days (4 total), add to 500 ml ice and neutralize using H₂O₂, centrifuge first quench (4 hrs at >4000 rpm), and wash with HCl:H₂O (1:10 v/v) until sulfate free. Synthesis procedure 4 includes: add 100 mg MoS₂ to clean and DRY schlenk flask (50 ml), add 10 ml of n-butyllithium [use extreme caution with reagent], stir for 4 days, quench with 500 ml hexane and filter over 0.2 μm PTFE filter, and repeat 2× (total 1500ml hexane). Synthesis procedure 5 includes: add 1000 mg MoS₂ to clean and DRY schlenk flask (50 ml), add 10 ml of n-butyllithium [use extreme caution with reagent], stir for 4 days, quench with 500 ml hexane and filter over 0.2 μm PTFE filter, and repeat 2× (total 1500 ml hexane).

Sometimes samples become too thick to filter. The addition of 10-30% acid in solution can aid in filtration over 0.2 μm PTFE membranes. However when it becomes difficult to filtrate over 2 Days and the solution is very thick, samples are washed by collection with DI into 200 ml solution, stirred for 1 hr and centrifuged for 8000 rpm 10× and recollected with final filtration in acidic solution.

Each filter was rinsed with de-ionized water until free of ions (permeate had 0 ppm Total Dissolved Solids TDS). Then each filter was tested using water samples.

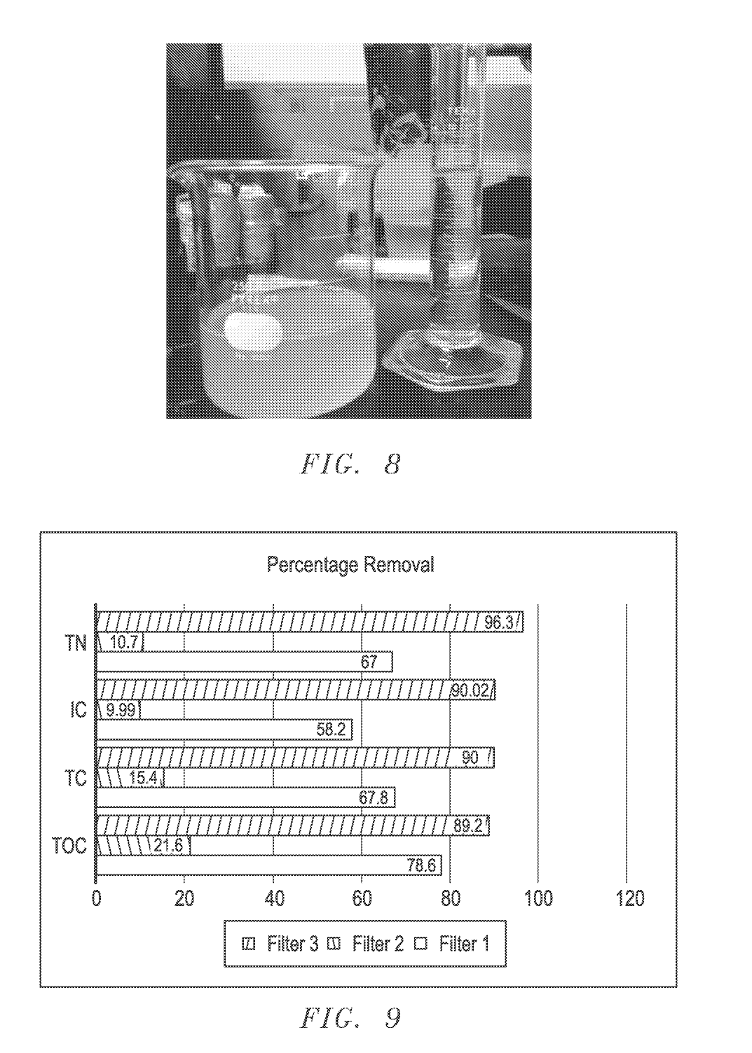

FIG. 6 is a graph of the material tap water flux in gallons per foot per day using membrane synthesized using Synthesis procedure 1, 2, and 3.

FIG. 7 is a graph of the rejection of total dissolved solids from tap water using membrane synthesized using Synthesis procedure 1, 2, and 3.

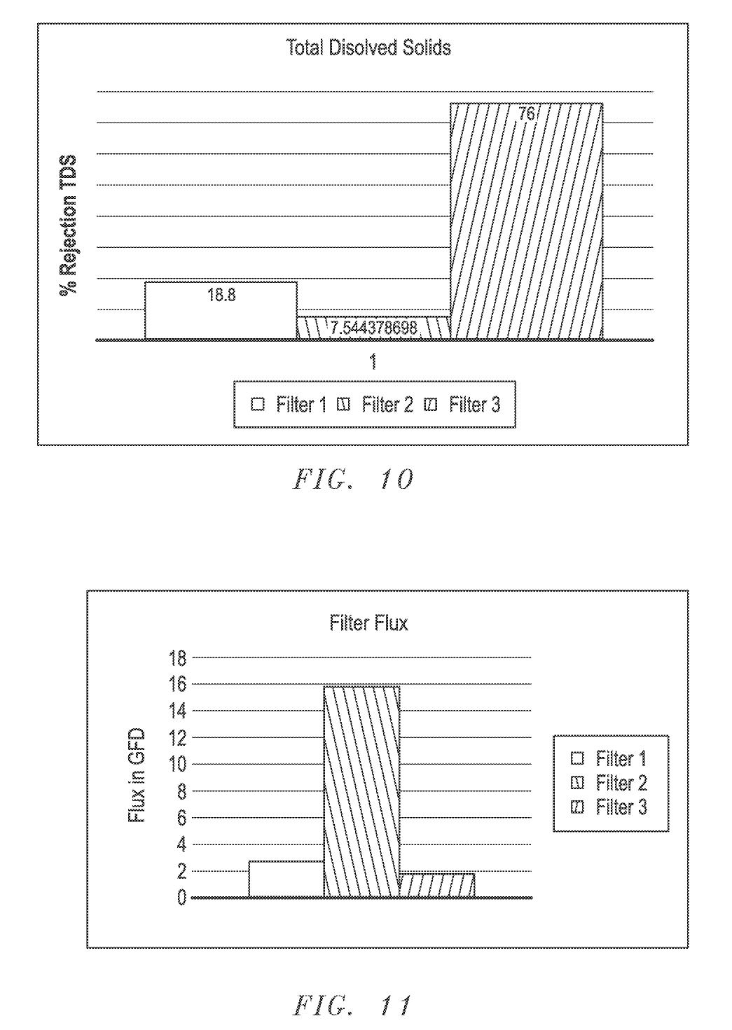

FIG. 8 shows wastewater from hydraulic fracturing prior to filtration (left, beaker) and after filtration using the present invention the filtrate (right, in the graduated cylinder).

Each filter was rinsed with de-ionized water until free of ions (permeate had 0 ppm Total Dissolved Solids TDS). Then each filter was tested using water samples. During filtration, the membranes were evaluated for flux and permeate samples were tested for TDS and then collected and sent to Inform Environmental for third party evaluation of hydrocarbons and nitrogen. Procedures are as follows: Water filtration will be performed using vacuum (>1 bar); 100 ml will be collected from a 25 mm membrane; 30 ml of collected sample will be shipped with ice or freezer packs to Inform Environmental LLC for third party validation; and Initial screening for 35 volatile and non-volatile compounds.

| | Total Carbon: | | Inorganic Carbon: | |
|---|---|---|---|---|
| | TC | Std. Dev. | IC | Std. Dev. |
| | Conc. (mg/L) | (mg/L) | Conc. (mg/L) | (mg/L) |
| Unfiltered | 425 | 6.44 | 225.3 | 3.63 |
| Filter 1 | 136.7 | 2.16 | 94.08 | 1.64 |
| Filter 2 | 359.4 | 6.8 | 202.8 | 1.59 |
| Filter 3 | 42.3 | 1.85 | 20.7 | 3.63 |
| Blank | not detected | not detected | not detected | not detected |

| | Total Organic Carbon: | | Total Nitrogen: | |
|---|---|---|---|---|
| | TOC | Std. Dev. | TN | Std. Dev. |
| | Conc. (mg/L) | (mg/L) | Conc. (mg/L) | (mg/L) |
| Unfiltered | 199.7 | 7.39 | 247.1 | 3.92 |
| Filter 1 | 42.67 | 2.71 | 81.41 | 2.16 |
| Filter 2 | 156.5 | 6.98 | 220.7 | 5.48 |
| Filter 3 | 21.6 | 4.07 | 9.185 | 1.12 |
| Blank | not detected | not detected | not detected | not detected |

FIG. 9 is a plot of the percentage removal of total carbon, organic carbon, inorganic carbon, and total nitrogen.

FIG. 10 is a plot of the rejection of total dissolved solids using membrane synthesized using Synthesis procedure 1, 2, and 3.

FIG. 11 is a plot of the in gallons per foot per day using membrane synthesized using Synthesis procedure 1, 2, and 3.

Pure water flux with de-ionized (DI) water is used in determining the specific flux of a membrane and typically is used in characterizing the performance of the membrane. However, in this report we determined the actual flux of the membrane using produced water samples instead of DI water.

In this study provides two different materials were screened for capacity to remove all contaminants. The main objective was to determine performance of different material in different quantities. Filter #1 and #3 were made of the same material [synthesized using synthesis # but used in different quantities. Filter #2 was a similar material that was synthesized with a different protocol than material used in filter #1 and #3.

The present invention enables the reclamation of saleable products including dehydrated clean crude oil, fresh water, brine water at lower cost due to rapid prototyping providing flexibility for development to suit any feed waste streams, it can be paired to current water technologies to save energy and increase equipment lifetime and it allows low-risk heavy waste stream recycling for groundwater recharge.

The present invention provides scaling membranes of commercial size for use in membrane bioreactor. Membranes using nano-composites have been shown to filter water at a molecular scale and provide biocidal and antifouling applications due to its resistance to proteins and chlorine.

The present invention provides advanced tertiary treatments that consist of removal of suspended solids and dissolved solids, which include nutrients and disinfectant. These treatments involve nitrogen and phosphorus removal by biological methods. The removal of organics and metals is done through carbon adsorption or chemical precipitation, then the further removal of suspended and dissolved solids is performed by filtration, coagulation, ion exchange, reverse osmosis and other techniques like ozone and UV light irradiation to remove biological agents. The present invention uses nanofiltration to allow water being passed through a thin film to remove biological pathogens and potentially avoid the overall biological treatment of wastewater and to reduced membrane biofouling, reduced need for aeration, increase the quality of effluent and reduce the energy use, carbon footprint and overall cost.

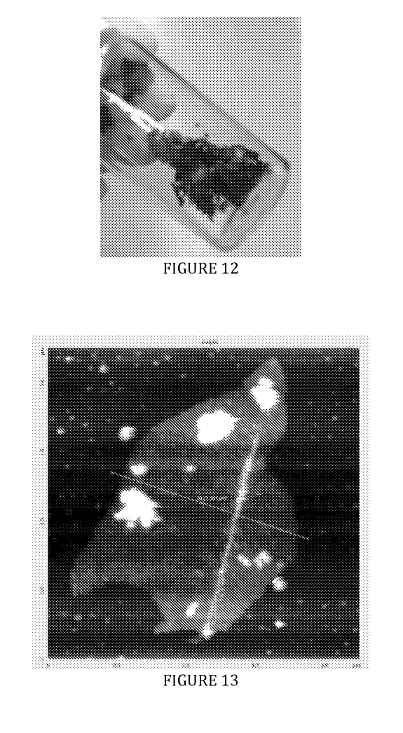

FIG. 12 is an image of a single layer material of the present invention.

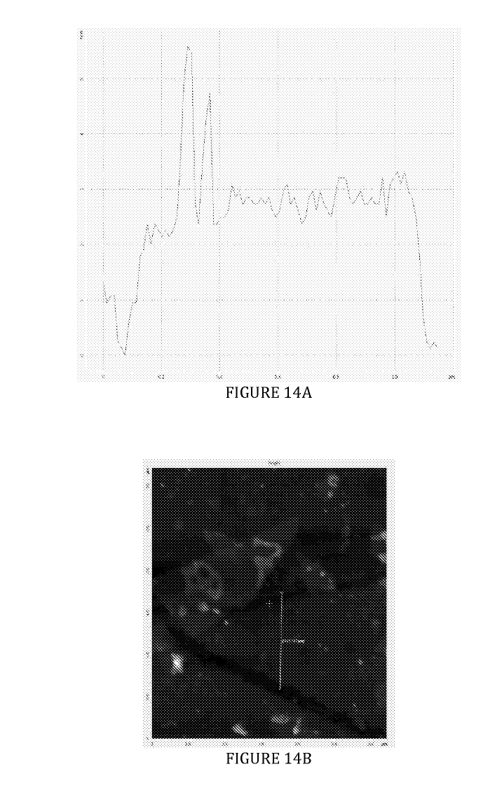

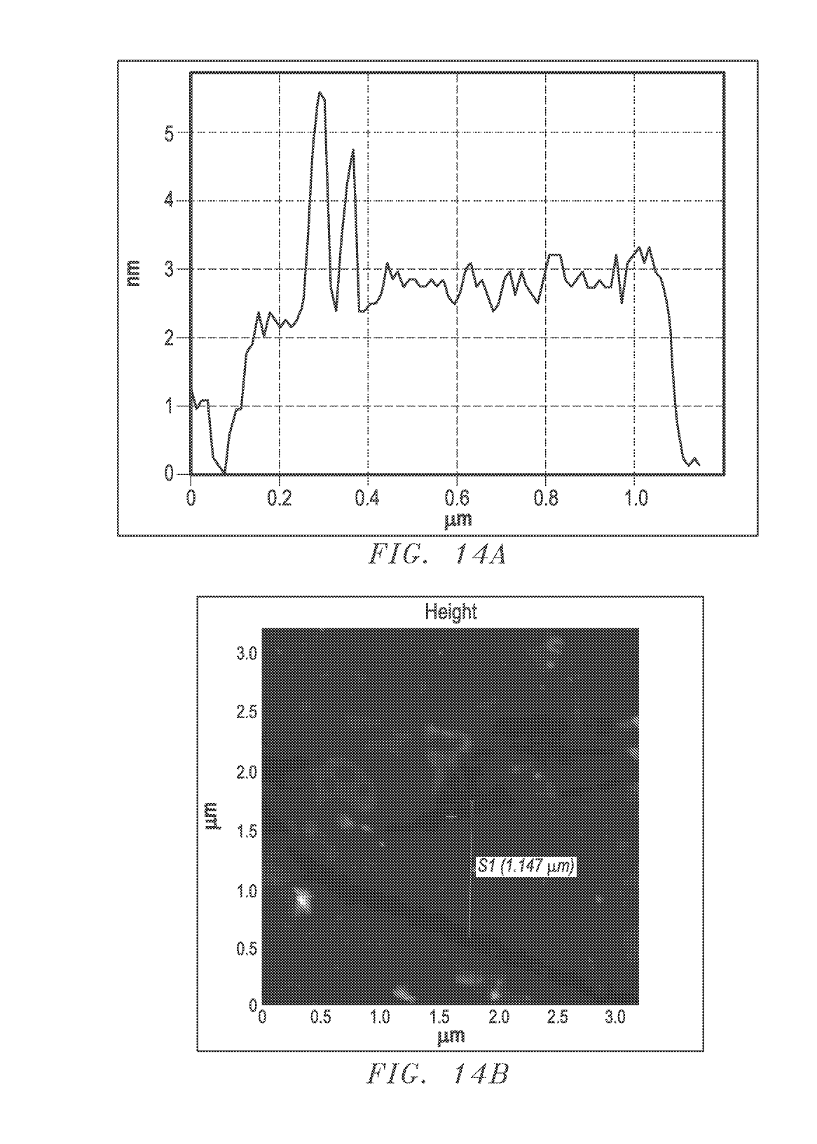

FIG. 13 is an Atomic Force Microscope (AFM) image of a single layer 1.5 μm in diameter.

FIG. 14A is an image of the AFM measurement of single layer thickness of a graphene oxide flake. FIG. 14B is an Atomic Force Microscope (AFM) image of a single layer graphene oxide flake with a ˜2 nm height.

The table below shows a summary of membrane and module configurations: available from prototype testing DS: Desalination, ED: Electrodialysis, PR: Process Recovery, WT: Water Treatment, WWT: Wastewater Treatment

| | Module | | | | |
|---|---|---|---|---|---|
| | configuration | | | | |
| Membrane | or operating | Driving | | Common | |
| config | method | force | Pore size | Applications | Example |
| Flat Sheet | Plate and | Pressure | MF/UF | WWT, EDI | Pall DT ™, Electrocell |
| (FS) | frame (PF) | | | | (EC) |
| | Immersed | Vacuum | MF/UF | iMBR | Kubota, Toray |
| | membranes | | | | Membray, Mycrodyne |
| | | | | | Bio-Cel ®, Pure Envitech |
| | | | | | SBM |
| | Spiral wound | Pressure | UF/RO | DS, PR | Dow |
| | (SW) | | | | Filmtec, Hydranautics, Toray |
| | | | | | Romembra, Woongjin |
| | | | | | CSM ® |
| Hollow | Contained in | Pressure | MF/UF/RO | WT, PR, etc. | Asahi Microza ®, Toyobo |
| Fiber (HF) | pressure | | | | Hollowsep ®, GE ZW1500 |
| | vessels | | | | |
| | Immersed | Vacuum | MF/UF | WT, iMBR | GE ZW500, Asahi |
| | module | | | | Microza ®, Mitsubishi |
| | without | | | | Sterapore ™, Econity |
| | pressure | | | | |
| | vessels | | | | |
| Tubular | Pressure | Pressure | MF/UF | WWT, PR, | Koch Abcor ®, ITT PCI, |
| (TB) | filtration | | | sMBR | |
| | Vacuum | Vacuum | MF/UF | sMBR | Norit Airlift ™ |
| | filtration with | | | | |
| | bubbling | | | | |

The present invention provides membranes membrane fabrication using Kubota polypropylene membranes. Nanomaterials are deposited using spin coating, spray coating, and vacuum deposition. In one embodiment, the membranes were formed using vacuum deposition with a special chamber designed to keep a solution reservoir and enable even deposition of nano-composite material.

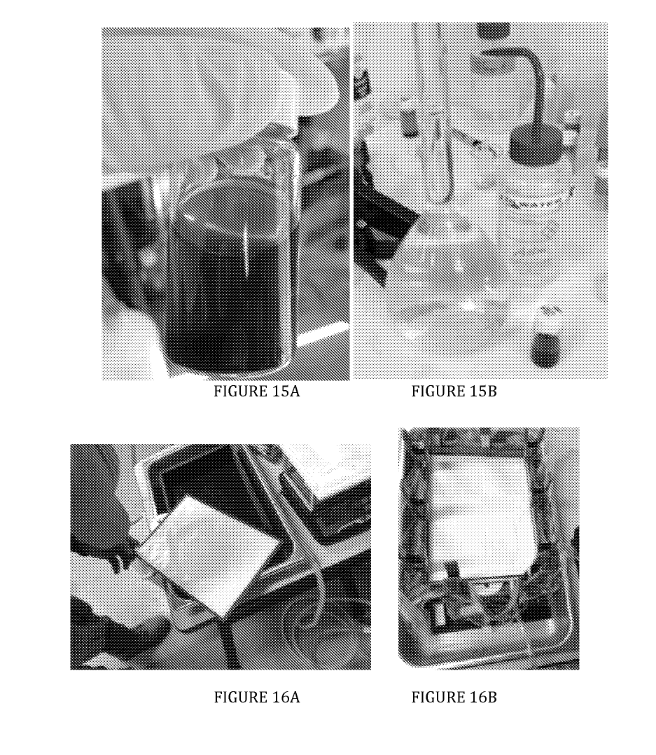

FIG. 15A is an image of the stock solution of nanomaterial and FIG. 15B is an image of the dilute solution prepared for membrane deposition.

FIG. 16A is an image of the preparation of flat sheet polypropylene and FIG. 16B is an image of leveled vacuum deposition chamber.

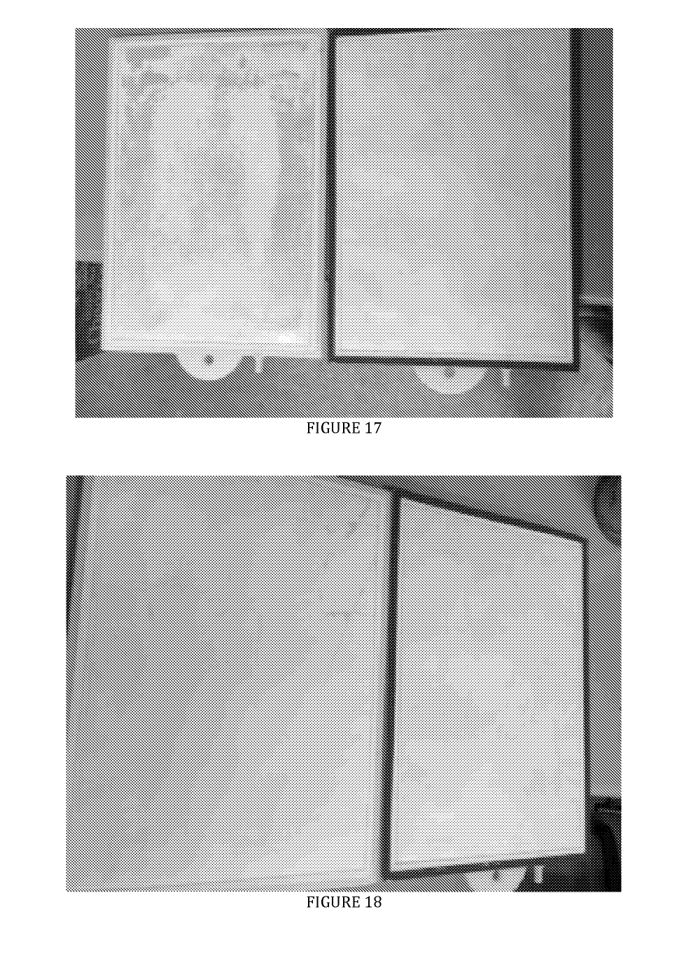

FIG. 17 is an image of the unreated hydrophilic nanomaterial membrane on the right and the hydrophilic nanomaterial membrane pretreated with soap solution dried after deposition on the left.

FIG. 18 is an image of the membrane with a nanomaterial thin film on the right and the membrane without nanomaterial on the left.

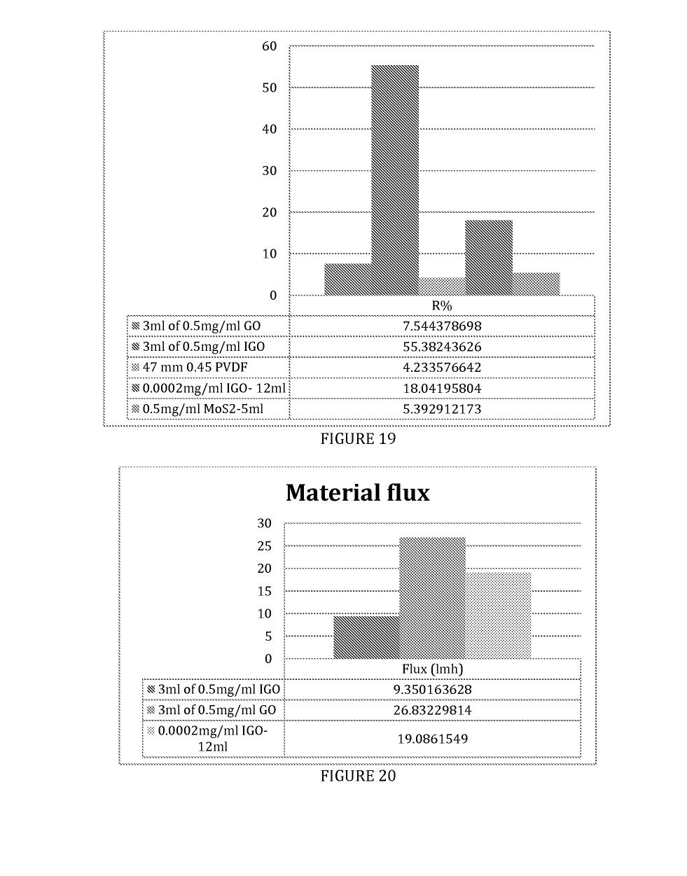

FIG. 19 is a graph of the TDS testing % R for GO membranes.

FIG. 20 is a graph of the material flux for GO membranes.

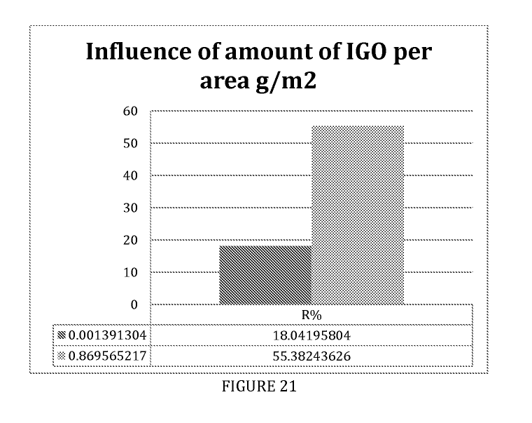

FIG. 21 is a graph of the influence of the amount of IGO per area.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. In certain embodiments, the present invention may also include methods and compositions in which the transition phrase “consisting essentially of” or “consisting of” may also be used.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A treatment system for removing one or more agents from a fluid stream, the treatment system comprising:
a vessel housing comprising a housing inlet and a housing outlet;
an inlet flow path fluidly connected to the housing inlet to transport a fluid stream from a source to the vessel housing;
a drain fluidly connected to the housing outlet to discharge a treated fluid stream from the vessel;
a permeable graphene filter for biological treatment, physical treatment or both of the fluid stream positioned between the housing inlet and the housing outlet to remove one or more agents from the fluid stream to form the treated fluid stream, wherein the permeable graphene filter comprises a polymer composite of one or more layers of a graphene material assembled in sp2 hybridized structures comprising carbon-carbon bonds and the permeable graphene filter is made permeable by chemical doping with heteroatoms, chemical destruction of lattice by UV-Ozone treatments, chemical disruption of the lattice by bonding or by removal of areas using plasma, or electron beam lithography.

2. The system of claim 1, wherein the graphene material comprises a graphene or a graphene oxide.

3. The system of claim 2, wherein the graphene material further comprises one or more heteroatoms selected from oxygen, nitrogen, hydrogen, sulfur, or one or more metals.

4. The system of claim 1, wherein the permeable graphene filter comprises at least one channel opening for receiving the fluid stream.

5. The system of claim 1, wherein the permeable graphene filter comprises a single or multilayered thin layer composite.

6. The system of claim 1, wherein the vessel housing comprises 2 or more permeable graphene filters.

7. The system of claim 6, wherein the 2 or more permeable graphene filters comprise different size nanochannels positioned between or across the 2 or more permeable graphene filter and functionalized with one or more heteroatoms to control a size exclusion of a filtration, to control a specificity of a filtration or both.

8. The system of claim 6, wherein the 2 or more permeable graphene filters are cross-flow, spiral wound or dead-end filtration.

9. The system of claim 1, wherein the fluid stream is a gas.

10. The system of claim 1, wherein the fluid stream comprises one or more selected from water, wastewater, oil, grease, oil, biological molecules, chemicals, organic molecules, inorganic molecules, chemical dyes, petrochemicals, pharmaceuticals, heavy and radioactive waste.

11. The system of claim 1, wherein the permeable graphene filter extracts solvents that comprise petrochemicals, removes free fatty acids, performs a desulfurization, performs a deacidification, performs a solvent recovery in lube dewaxing, isolates and/or concentrates pharmaceuticals, or concentration and/or purifies bioactive compounds.

12. A stackable filter unit comprising:
one or more permeable graphene filters wherein each of the one or more permeable graphene filters comprise a first planar surface opposite a second planar surface separated by a filtering wall, wherein the second planar surface is designed to mate with the first planar surface of a second permeable graphene filter; and
a nano-thin film or polymer composite layer for biological treatment, physical treatment or both placed in contact with the first planar surface, the second planar surface or both, wherein the nano-thin film or polymer composite layer comprises one or more layers of a graphene material assembled in sp2 hybridized structures comprising carbon-carbon bonds and the permeable graphene filter is made permeable by chemical doping with heteroatoms, chemical destruction of lattice by UV-Ozone treatments, chemical disruption of the lattice by bonding or by removal of areas using plasma, or electron beam lithography.

13. The filter of claim 12, wherein the graphene material comprises a graphene or a graphene oxide.

14. The filter of claim 12, wherein the graphene material further comprises one or more heteroatoms selected from oxygen, nitrogen, hydrogen, sulfur, or one or more metals.

15. The filter of claim 12, wherein the permeable graphene filter comprises at least one channel opening for receiving a fluid stream.

16. The filter of claim 12, wherein the filter comprises connecting elements to releasably connect a unit of stackable filter units that comprise one or more filters.

17. The filter of claim 12, wherein the fluid stream is a gas.

18. The filter of claim 12, wherein the fluid stream comprises one or more selected from water, wastewater, oil, grease, biological molecules, chemicals, organic molecules, inorganic molecules, chemical dyes, petrochemicals, pharmaceuticals, heavy waste, and radioactive waste.

19. The filter of claim 12, wherein the permeable graphene filter extracts solvents that comprise petrochemicals, removes free fatty acids, performs a desulfurization, performs a deacidification, performs a solvent recovery in lube dewaxing, isolates and/or concentrates pharmaceuticals, or concentration and/or purifies bioactive compounds.

20. A method for filtering waste or an agent from a fluid stream, the method comprising:
receiving a fluid stream from a source outside a treatment system; and
contacting the fluid stream with a permeable graphene filter configured for biological and physical treatment of the wastewater by removing one or more agents from the fluid stream to form the treated fluid stream, wherein the permeable graphene filter comprises a polymer composite one or more layers of a graphene material assembled in sp2 hybridized structures comprising carbon-carbon bonds and the permeable graphene filter is made permeable by chemical doping with heteroatoms, chemical destruction of lattice by UV-Ozone treatments, chemical disruption of the lattice by bonding or by removal of areas using plasma, or electron beam lithography; and
discharging the treated fluid stream from the treatment system.

21.-28. (canceled)
